(19) United States
(12) Patent Application Publication
(10) Pub. No.: US 2005/0268400 A1
(43) Pub. Date: Dec. 8, 2005

(54) Converter system to couple and command a support of a patient to be operated

(76) Inventors: Francesco Siccardi, Sonvico (CH); Frederic Laude, Gordola (CH); Mattia Berguglia, Gordola (CH)

Correspondence Address: DICKSTEIN SHAPIRO MORIN & OSHINSKY LLP, 2101 L Street, NW, Washington, DC, 20037, US

(21) Appl. No.: 11/147,446

(22) Filed: Jun. 8, 2005

(30) Foreign Application Priority Data
Jun. 8, 2004 (FR) 0406271

(51) Int. Cl. A61G 13/12

(52) U.S. Cl. 5/621; 5/624

(57) ABSTRACT

A system to perform, under optimal conditions, surgical operations on limbs of human bodies lying on bases to extend the patient, comprising a surgery table and a converter, the converter including at least five sub-systems with different liberty degrees of movement.

### BACKGROUND OF THE INVENTION

1. Field of the Invention

The present Invention concerns a system to perform, under optimal conditions, surgical interventions on animal body limbs.

In particular the invention relates to a system to perform, under optimal conditions, surgical interventions on animal body limbs of patients lying on an surgical table connected to a converter.

More particularly the invention concerns a converter system to be coupled with, to regulate and to centrally command tables, beds, supports of extended patients who have to undergo chirurgical operations to the inferior limbs such as the legs.

2. Description of the Prior Art

The operations of animal, human body limbs are generally practised by lying the patient on a surgical table which is generally provided with restricted functional means or members to reach the best patient disposition over the surgeon. Normally such tables are vertically adjustable with the aid of poor associated means. There are however lots of surgical interventions which need positioning and specific functions of great importance for the best success of said operations.

Just to fix the ideas (without introducing restrictions), for the operations of the inferior limbs e.g. associated to the ankle, the patient or, better, the limbs in question must be capable of taking critical positions over the surgeon, all the more that said limbs have often to undergo traction or stretching efforts.

Up to now and at the best of our knowledge there are no systems capable to answer at least partially to all the pre-operative functions preferably with the aid of means centralized and easy to reach by the chirurgical team.

U.S. Pat. No. 5,645,079 (to Zahiri H. et al) describes an orthopaedic apparatus which includes:
a clamping section comprising a cross bar, with two clamping blocks at its opposite ends and a sliding block;
a tilting section including a gear box attached to said sliding box and a tilting part tiltably connected to said gear box;
a swinging section including a gear box connected to the tilting part and a swingable part swingably connected to the gear box; and
an extended rotatable section including a gear box connected to the tilting part and to a sliding track rotatably connected to the gear box.

U.S. patent Publication No. 2003/0028967 describes a device consisting of:—a base attachable to a surgical table;—a post attachable by clamp;—a support arm pivotably attachable to the base;—and an expandable and retractable position actuator pivotably mounted on both said support arm and base.

### SUMMARY OF THE INVENTION

A first object of the present invention is to provide a system which eliminates the inconveniences and the gaps of the Prior Art. An other object is to provide an hospital converter system showing the advantages of being compact and compatible with all types of conventional surgical tables with the additional advantage of being controllable and activated by concentrated devices immediately accessible to the surgical team.

A further object is a method to simply operate said systems and the relevant devices.

Typically the converter system according to the invention consents to carry out the surgical operations on the inferior limbs of a patient in extended position, under optimized conditions.

The system comprises at least:
a first multi-functional articulated sub-system (S1) with an articulation to couple and connect to an extension base, with at least three liberty degrees;
a second sub-system (S2) of support and movement of the patient limb coupling means, with at least two liberty degrees;
a third sub-system (S3) associated to said second sub-system (S2) with at least one liberty degree between said second sub-system (S2) and the following sub-system (S4);
a fourth sub-system (S4) of interconnections between said third sub-system (S3) and the next sub-system (S5) of said member coupling means with at least one liberty degree over (S3): and
a fifth sub-system (S5) of articulation and support of said patient member with at least three liberty degrees.

In a first embodiment the system of the invention shows further preferred characteristics separately or in combination wherein:
a) sub-system (S1) is a rotula mechanism;
b) sub-system (S2) is a binary track provided with holes or slits of linear fixation of sub-system (S3) and of rotation over a vertical axis:
c) sub-system (S3) is a carriage mechanism provided of means for its translation, for the rotation of sub-system (S2), and for the traction of the limb to be operated;
d) to said carriage are associated means for engagement within the holes or slits of the track, as well as a toothed wheel: a plate penetrates within the empty spaces between the wheel teeth to determinate the position of sub-system (S3), (S4) and (S5);
e) sub-system (S4) is a shoe in particular a rotula which matches and fits the limb foot; and
f) said sub-systems are assembled together in the operative phase whereas the command means are associated to the carriage in the initial phase of rough positioning.

In a preferred embodiment of the invention, the system includes a sixth sub-system (S6) to optimize the limb position over the surgeon, including means (FM) to feed and control a compressed fluid flow (CFF) to an elastic pneumatically modifiable body (PMB) e.g. in the form of a cushion, small mattress, elongated balloon, located under the lying patient; the feeding and regulating means (FM) being associated to the converter system (CO) whereas the pneumatically modifiable body may preferably be embedded in the lying patient supporting table (ST). The means (FM) of the sub-system (S6) are activated by the surgical team to finely regulate the height, distance, inclination of the limb over the surgeon.

The various aspects and advantages of the invention will become apparent from the following detailed description, discussion and appended claims, taken in conjunction with the accompanying drawings.

### BRIEF DESCRIPTION OF THE DRAWINGS

Referring particularly to the drawings for the purpose of illustration only and not limitation, there is illustrated:

FIG. 1 is a block scheme of the converter system according to the invention;

FIGS. 2, 3, 4, 4A, and 5 are prospective views of an equipment to embody said system;

FIG. 6 is a front view of the equipments of FIGS. 2 and 5; and

FIG. 7 is a front view of the equipment portion comprised in the circle of FIG. 6.

### DESCRIPTION OF THE PREFERRED EMBODIMENT

Briefly described, the invention is a Converter System carrying centralized command means of associated sub-system acting on the surgical table accommodating the patient to be operated, to reach each time the optimal position of the patient limbs over the surgeon.

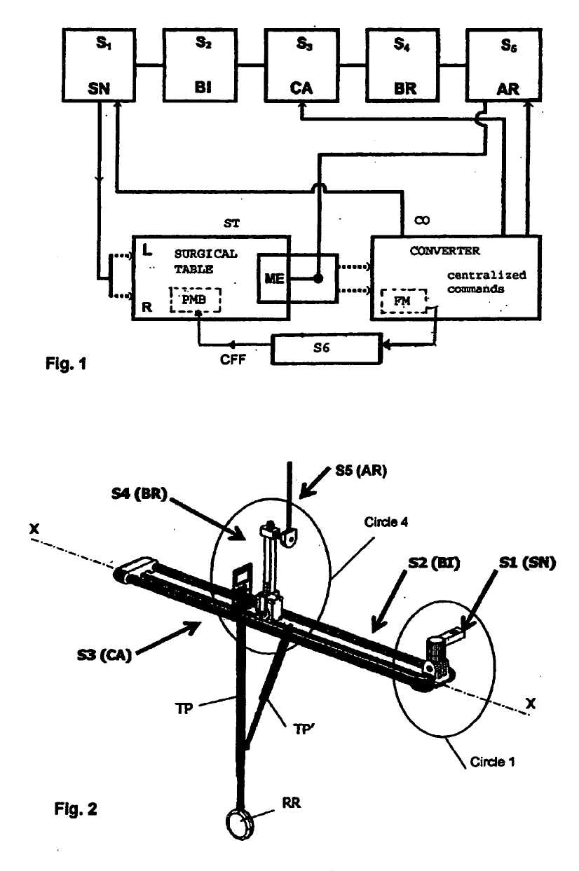

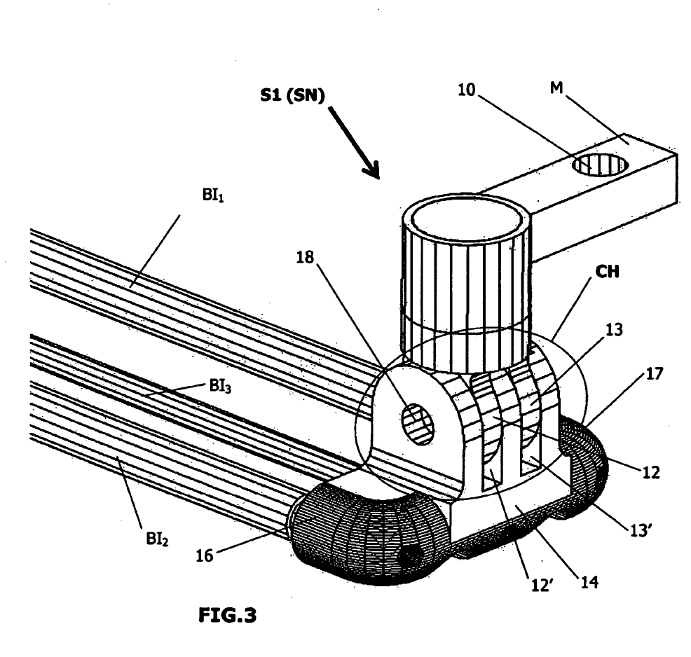

The system of FIG. 1 comprises the surgical table (ST) and the converter system (CO) of the invention comprising at least:
a first sub-system (S1) preferably involving an articulation mechanism (SN) in a stationary special position;
a second sub-system (S2) preferably in form of a binary track (B1) associated at one of its ends to said sub-system (S1) (SN) in such a way to consent to said (S2) at least two movement freedom degrees;
a third sub-system (S3) preferably in form of a carriage (CA) associated to said articulated binary track (BI);
a forth sub-system (S4) preferably in form of an arm connected at one of its ends to sub-system (S3) over which it has at least one freedom degree of movement; and
a fifth sub-system (S5), preferably in form of a patient limb support (AR), having at least three freedom degrees.

The converter system comprises a connection or interface (M) with a coupling means, f.i. a hole or slit (10), which corresponds to a pivot of the surgical table (ST) (not represented) so the bring about the articulated clamping to said system of the invention.

Said articulation of sub-system (S1) comprises also a mechanism preferably in the form of a rotula, which is accommodated with its male expansions (12 and 13) within the opening base of the female expansion (12′ and 13′) of the base (14) of (SN), which has on its turn, two lateral expansions (16 and 17) for the application of the ends of arms (BI1) and (BI2) of track (BI).

In the represented case, an hole (18) offers the housing to a pivot (not shown).

The sub-system (S2) comprises the two bodies forming the binary track, (BI1) and (BI2) and additionally has a third tubular element (BI₃) parallel to (BI1) and (BI2), preferably at the centre of these last elements. Element (BI3) works substantially as a means to locate carriage (CA) in the positions established in the pre-operative phase schematically represented by the series of holes or (even better) slits (FR1, FR2 . . . FRi . . . FRn).

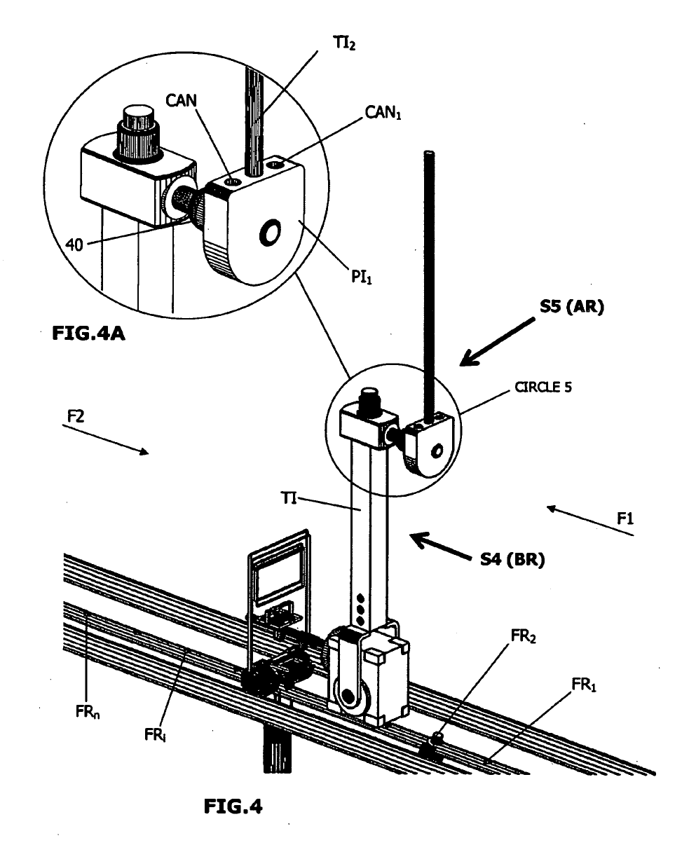

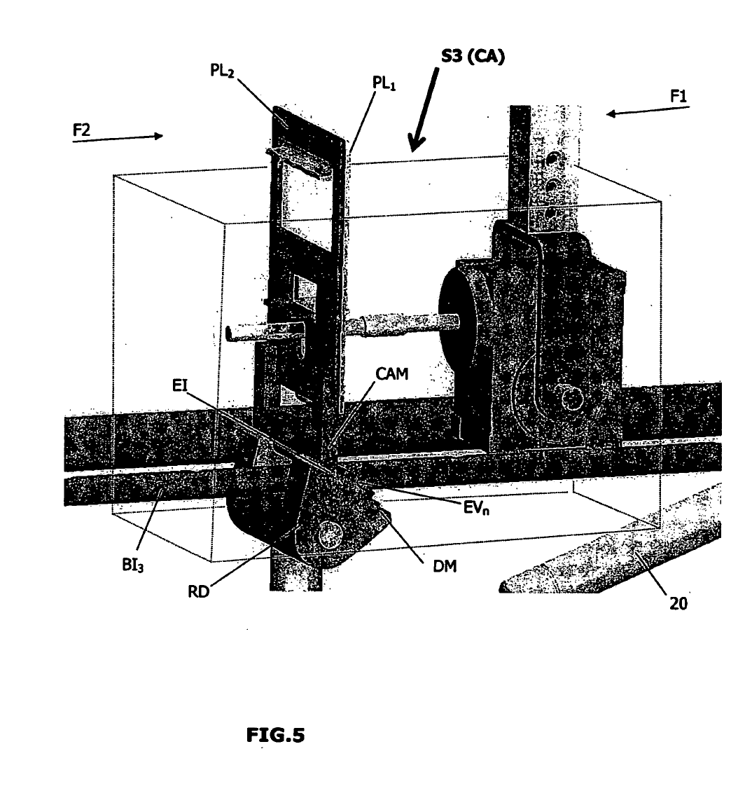

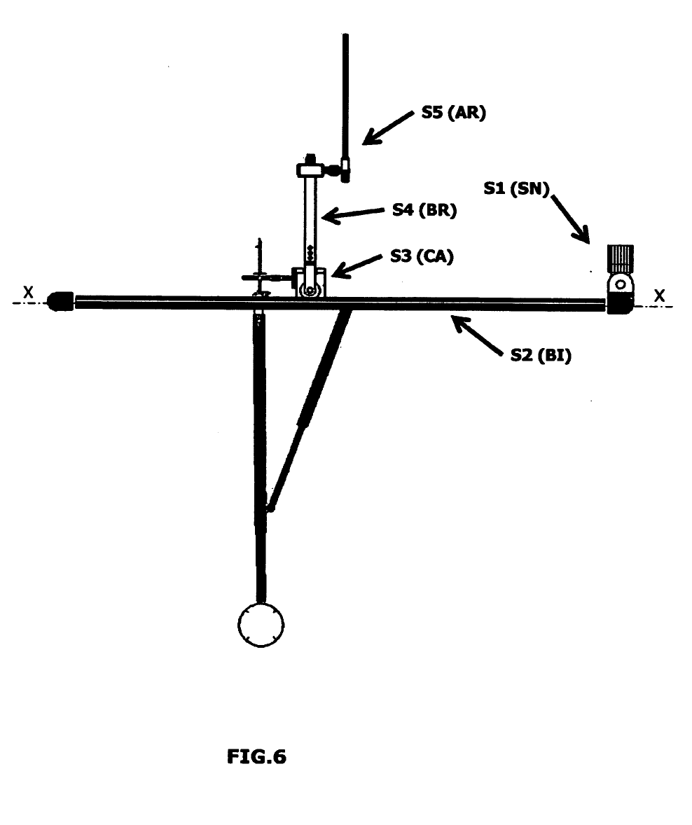

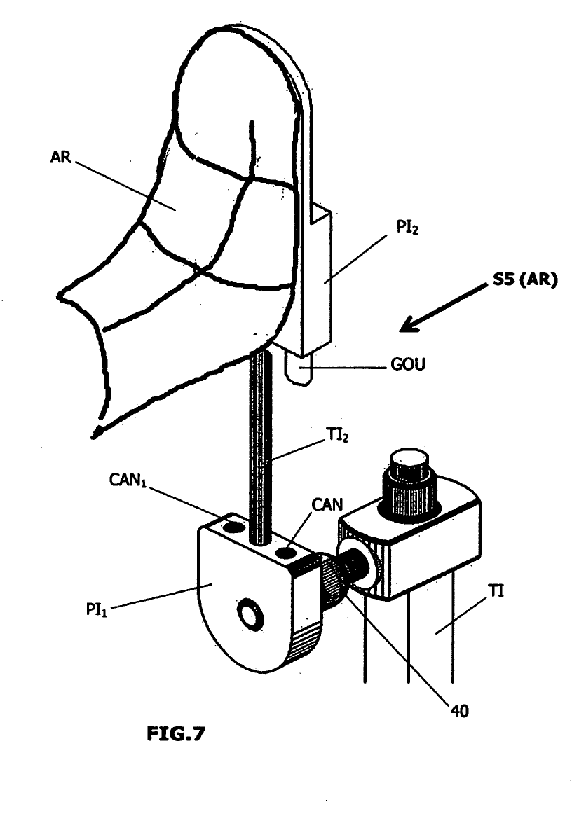

Sub-system (S3) comprises substantially said carriage (CA) shown in the circle 4 of FIG. 2 which in its first embodiment of FIG. 4, (representation on enlarged scale of carriage CA of FIG. 2) involves a first mechanism (M) to position and fix carriage (CA) on the track (BI) thanks to said holes or slits (FR1, FR2, . . . Fri . . . FRn); in FIG. 5 said mechanism has essentially the form of a cam (CAM) whose lower end (EI) penetrates between the teeth of toothed wheel (RD). In the embodiment of FIG. 5 the number of the teeth are six, the inter-teeth empty spaces are seven and the passage from one space to the other determines a rotation (over axis X-X of FIG. 6) of 10° with a total amplitude of 50°.

The carriage mechanism translation along axis X-X (which on its turn can rotate around the fixed axis PF of a total angle of 50°) is schematically represented in FIGS. 4 and 4A which are two views according to arrows (F1 and F2) of same device.

The fourth system (S4) is indicated in the circle 4 and comprises the rod (TI) articulated at its lower end on (S3).

At the upper end of (S4), the rod (TI) has an articulation (40) to couple with the fifth subsystem (S5) which comprises in itself a housing of support and fixation of limb AR, f.i. in form of a console.

Said console comprises also a number of holes (SN1-SNn) in which penetrates the rod (50) for the engagement of the element (AR) (generally) to the patient foot.

As anticipated a sixth sub-system (S6) is preferably present, comprising:—a pneumatically modifiable body (PMB), f.i. in the form of a cushion, mattress, balloon and the like, located under the lying patient body or limb;—feeding and regulating means of compressed fluid flow (CFF). The modifiable body (PMB) is associated to the surgical table (ST) whereas the fluid generating and feeding means (CFF) are incorporated in the converter (CO).

A method to embody the system according to the invention comprises the steps of:
Connecting said global system to a surgery table through said first sub-system (S1);
Rough positioning of the carriage of the sub-system (S3) along the sub-system (S2);
Placing on said to be operated limb, a means for its engagement to sub-system (S5);
Fine positioning of sub-system (S3) to offer to the surgeon the optimal conditions for translation, rotation and traction of the member to be operated.

For clarity scruple the invention has been described with reference to the simplest embodiment form shown in the accompanying drawings. However it is to be intended that the invention is not limited to said embodiments but is susceptible of all the chances, additions, alternatives and the like, which, being familiar to the mean expert of the Art, are to be considered as falling within the scope and spirit of same invention.

1. A system to perform, under optimal conditions, surgical operations on limbs of animal bodies lying on bases to extend the patient to be operated, said system comprising at least a surgery table and a converter, characterized in that said converter comprises at least:
a first multi-functional articulated sub-system (S1) with an articulation to couple and bond to said extension base, with at least three liberty degrees;
a second sub-system (S2) of support and movement of said patient limb coupling means, with at least two liberty degrees;
a third sub-system (S3) associated to said second sub-system (S2) with at least one liberty degree between said second sub-system (S2) and the following sub-system (S4);
a fourth sub-system (S4) of interconnection between said third sub-system (S3) and the next sub-system (S5) of said member coupling means, with at least one liberty degree over (S3): and
a fifth sub-system (S5) of articulation and support of said patient member with at least three liberty degrees.

2. A system according to claim 1, comprising a sixth sub-system to finely optimize the limb position over the surgeon.

3. A system according to claim 1, wherein said first sub-system (S1) consists of a rotula mechanism.

4. A system according to claim 1, wherein said second sub-system (S2) consists of a binary track mechanism provided with holes or slits of linear fixation of sub-system (S3) and capable of rotation over a vertical axis.

5. A system according to claim 1, wherein said third sub-system (S3) consists of a carriage (CH) mechanism provided with means for its translation, for the rotation of sub-system (S2) and the traction of the limb to be operated.

6. A system according to claim 5, wherein to said carriage are associated means for engagement within said holes or slits (FR) of track (B3) and a toothed wheel (DM), within the inter-teeth empty spaces of which a plate (CAM) penetrates which determines the position of sub-systems (S3), (S4) and (S5).

7. A system according to claim 1, wherein said fourth sub-system (S4) consists of a shoe (AR) in particular of a rotula which fits to the foot of the member to be operated.

8. A system according to claim 2, wherein said sixth sub-system comprises means to feed and control a compressed fluid flow to an elastic pneumatically modifiable body in the form of a cushion, small mattress, elongated balloon, located under the lying patient, said feeding and control means being associated to the converter system within the reach of the surgeon to finely regulate the height, distance, inclination of the limb over same surgeon.

9. A system according to claim 1, wherein said sub-systems are combined the one with the other in the operative phase and the command means are associated to the carriage at the initial phase of the preliminary positioning.

10. A method for embodying the system according to claim 1, comprising the steps of:
connecting said converter system to a surgery table through said first sub-system (S1);
rough positioning of the carriage of the sub-system (S3) along the sub-system (S2);
placing on said to be operated limb, a means for its engagement to sub-system (S5);
fine positioning of sub-system (S3) to offer to the surgeon the optimal conditions for translation, rotations and traction of the member to be operated; and optionally
ultrafine positioning of the limb over the surgeon by pneumatically acting on means to control the flow of the fluid feeding said sixth sub-system.
